(19) United States
(12) Patent Application Publication
(10) Pub. No.: US 2009/0269476 A1
(43) Pub. Date: Oct. 29, 2009

(54) PREPARATION OF EVISCERATED RAW WHOLE LOBSTER

(75) Inventors: Tony Jabbour, Halifax (CA); John James Garland, Halifax (CA); Matthew Sean O'Leary, Halifax (CA); Victor Lamont Lovitt, Boutilier's Point (CA)

Correspondence Address: SMART & BIGGAR;P.O. BOX 2999, STATION D, 900-55 METCALFE STREET, OTTAWA, ON, K1P 5Y6, CA

(73) Assignee: CLEARWATER SEAFOODS LIMITED PARTNERSHIP, Halifax (CA)

(21) Appl. No.: 12/428,805

(22) Filed: Apr. 23, 2009

Related U.S. Application Data
(60) Provisional application No. 61/047,203, filed on Apr. 23, 2008.

(51) Int. Cl. A22C 29/02; A23L 1/33; A22C 29/00

(52) U.S. Cl. 426/643; 452/8; 452/116; 426/524

(57) ABSTRACT

A method for producing a seafood product comprising a lobster in an intact shell said method comprising applying high pressure to effect detachment of the meat from the shell and thereafter removing the internal organs of the lobster using vacuum aspiration. The invention further includes seafood products prepared by the claimed methods.

### CROSS-REFERENCE TO RELATED APPLICATIONS

This application claims the benefit of and priority from U.S. Provisional Patent Application No. 61/047,203 filed Apr. 23, 2008, the full disclosure of which is incorporated hereby reference.

### FIELD OF THE INVENTION

This application relates to a method of processing whole lobster and, more particularly, to a method for producing a seafood product comprising whole lobster having improved flavour, colour and texture.

### BACKGROUND OF THE INVENTION

Whole lobster in the shell is highly prized as a food item and is generally regarded as a premium seafood product. Traditionally, whole lobsters have been prepared by boiling the animals while still alive. Boiling provides the dual benefit of cooking the lobster while effecting detachment of the meat from the shell. However, provision of whole lobsters to consumers has proven to be difficult. If provided live, whole lobsters must be properly maintained in order to ensure that the meat is safe to eat and of good quality. Many consumers have neither the expertise nor the proper equipment to maintain and care for live lobsters. Furthermore, cooking live animals can be distasteful for consumers, particularly those consumers who are sensitive to issues relating to compassionate treatment of animals.

Even greater difficulty is encountered if lobsters are killed prior to shipping to consumers. Once killed, the meat of the lobster quickly deteriorates and therefore it must be preserved, usually by freezing. However, if the lobster is frozen prior to cooking, the meat of the lobster becomes firmly affixed to the shell and it becomes virtually impossible to detach the shell from the meat, even after cooking. If the lobster is cooked before freezing, then the meat loses moisture and becomes less tender and flavourful. Furthermore, the shell of the lobster takes on a reddish colour which is indicative of prior cooking.

Removal of shells from lobsters is called “shucking.” Difficulties encountered in shucking of lobsters are related to their complex physiology. Lobsters are invertebrates belonging to the class known as “crustacea”. The skeletons of crustaceans are located on the exterior surface of their bodies and are known as exoskeletons. The exoskeleton forms a hard shell which protects the animal from predators. Although rigid, the shells of crustaceans are segmented to permit movement and are softer and more flexible than the shells of bivalve mollusks such as clams or oysters.

The shell of the crustacean is attached to the underlying muscle tissue by a continuous series of intracuticle fibres that extend across the entire animal. These intracuticle fibres extend from the surface of the muscle tissue to the outer surface of the shell via pore canals in the shell. This continuous attachment renders it difficult to remove the shell by manual cutting. In the case of lobster, it is virtually impossible to remove the shell from a raw, unprocessed animal. Accordingly, a variety of processing means have been developed to weaken the linkages affixing the shell to the body in order to facilitate removal of the shells and retrieval of the meat underneath.

Traditional methods for removing the shells of lobster involve cooking the animals prior to peeling. Heat denatures the linkages attaching the exoskeleton to the shellfish meat, thus facilitating removal of the shells. However, a difficulty with using heat to facilitate loosening of the shell is that the lobster meat underneath inevitably becomes cooked during the process. As discussed above, cooking of the lobster affects both its flavour and its texture. If the lobster is cooked prior to shipping to a consumer, then it will most likely be cooked a second time prior to serving, resulting in a further loss of moisture and tenderness.

Cooking represents a particular problem in the case of lobsters due to the differing thickness in various parts of the lobster's body. Cooking periods of sufficient length to loosen the shell of the tail of the lobster often result in overcooking of the meat in the smaller sections such as the claws and the legs.

Attempts have been made to loosen the shells of raw lobsters by soaking them in chemicals or in enzymes to loosen the connective tissue attaching the shells to the bodies. U.S. Pat. No. 6,235,338 describes a method of removing raw meat from the head-shell of a crustacean shellfish by immersing the animal in a solution of protease enzymes. The same patent also describes an additional method involving freezing of the animal followed by vacuum aspiration. However, these methods have not delivered consistent results and have not been widely adopted by the seafood industry.

In recent years, technology has been developed which has enabled foods to be processed using high pressure treatment. Exposure of foods to high pressure has been most commonly used to eliminate bacteria and other pathogens. High pressure treatment has been used as a preservation method for a variety of different types of foods including meats, fruits and other products. U.S. Pat. No. 6,426,103 (the '103 patent) issued on Jul. 30, 2002, describes the use of high hydrostatic pressure to eliminate pathogenic organisms from raw shellfish. Foods, including seafoods, subjected to high pressure have been shown to maintain a high quality in their texture, taste and appearance.

In addition to the elimination of pathogens, the '103 patent describes release of the meat of oysters which had been subjected to pressure at a minimum of 25,000 psi for a period of 15 minutes at ambient temperature. A similar effect was observed at higher pressures for shorter periods. Oysters are bivalve mollusks having hard shells consisting of two halves. The shell of the oyster is attached to a muscle called an adductor muscle. The '103 patent discloses that, following pressurization, the adductor muscle connective tissue of the oyster was denatured to a gel. As a result, a gap appeared between the two shell halves and the oyster meat slid out without the need for manual cutting. The '103 patent does not suggest that high pressure could be used to facilitate the removal of shells of animals other than oysters.

Canadian patent no. 2,548,237 describes a method for effecting detachment of the shells of lobster, crab or shrimp to facilitate their removal by exposing them to high pressure for a period of time sufficient to effect detachment of the body from the shell. This patent also describes seafood products produced using the claimed method.

High pressure processing has proved to be a highly effective method for effecting detachment of the shells of lobster. Through the use of high pressure processing, a variety of seafood products comprising uncooked lobster meat can be produced. For example, uncooked lobster meat from the tail, claws or other parts of the lobster can be recovered and sold as fresh meat. A particular advantage of high pressure processing of lobster is that it permits the production of seafood products comprising whole lobsters wherein the meat of the lobsters has been detached from the shells.

The development of high pressure processing of lobsters resulted in a significant benefit for consumers who wished to serve whole, intact lobsters as a seafood product. Whole lobsters treated using high pressure processing undergo detachment of the lobster meat from the shell. However, the shell of the animal remains fully intact and its appearance is unaltered by the process. The processed whole lobster can then be packaged and, optionally, frozen before shipment to the consumer. Since the meat of the lobster had been previously detached by high pressure processing, the consumer enjoys fresh meat which is easily removed from the shell.

Early demand from consumers for high pressure treated whole lobsters was enthusiastic. However, consumers reported complaints about both the texture and the colour of the meat from the tail regions of the animal. Meat from the tail region frequently displayed a mushy texture and it was often tainted with a blackish or greenish discolouration.

Kim et al. (J. Food Sci., 1996, 61:78-80) report mushy texture in the tail of crayfish meat following a relatively short period of iced storage and theorized that the mushiness could be caused by proteolytic enzymes in the hepatopancreatic tissue of the animal. Although Kim et al. did not perform any analysis on lobsters, they did state that digestive proteolytic enzymes have been studied in a wide range of decapods including, among others, lobsters and that the proteolytic enzymes have an active temperature zone of 45 to 50 degrees C.

Removal of the internal organs of an animal is referred to as evisceration. U.S. Pat. No. 3,773,962 describes the elimination of poor flavour and discolouration from lobster meat by removal of the lobster's stomach and stomach contents by flushing, vacuum evisceration or grappling. However, the process described does not result in removal of the hepatopancreas (also called “tomalley”) and therefore the process requires that the animal be boiled to inactivate the action of enzymes in the hepatopancreas. As a result, the lobster is cooked as part of this process thus eliminating the possibility of retaining the lobster in an uncooked state.

U.S. Pat. No. 6,159,528 describes preparation of a stuffed lobster product which process entails heat blanching of the animal, followed by vacuum evisceration to remove the internal organs and flushing with a lactic acid solution. The lobster is then stuffed with a blend of roe and shoulder meat obtained from other parts of the animal. This process results in removal of the internal organs, but the lobster is not raw and the resulting animal is not whole as portions have been removed to prepare stuffing. Heat blanching inevitably results in partial cooking of the meat.

U.S. Patent Publication No. 2005/0176356 describes a method of processing a crustacean to avoid staining of the meat by visceral tissue. The method comprises killing the animal by blanching at 70 to 100 degrees for 40-60 seconds, cutting the thorax, vacuum eviscerating the animal through the cut thorax and completing the evisceration by back flushing with water. The shell of the crustacean is then detached from the meat by use of a cycle of freezing and thawing. This process results in removal of the internal organs of the animal. However, it requires several steps which render it unsuitable for use in production of uncooked, whole lobster. Firstly, it requires blanching of the animal which, as described above, results in undesirable cooking of the meat. Furthermore, it requires cutting of the thorax of the animal which destroys the intactness of the animal's exterior. This process also requires the use of back-flushing in order to complete the evisceration process as evisceration through the thorax fails to completely remove the internal organs of the animal.

Both U.S. Pat. No. 6,159,528 and U.S. Patent Publication No. 2005/0176356 describe a shucking step which employs the application of a freeze/thaw cycle in order to effect detachment of the lobster meat from the shell. However, freeze-thaw cycles have met with limited success and frequently portions of the animal remain affixed to the shell following use of these methods.

Accordingly, a need exists for a method to produce an uncooked, whole lobster in the shell, which lobster has been treated to detach the meat from the shell and which meat demonstrates superior colour, flavour and texture.

### SUMMARY OF THE INVENTION

The present invention provides a method of processing a whole lobster comprising: exposing the whole lobster to external pressure of at least 25,000 psi for a period of time sufficient to effect detachment of the meat from the shell; removing the internal organs of the lobster through an aperture in the abdomen of the lobster.

The present invention further provides a method of processing a whole lobster comprising: exposing the whole lobster to pressure of at least 25,000 psi for a period of time sufficient to effect detachment of the meat from the shell; inserting a wand comprising a hollow tube into the abdomen of the lobster; applying vacuum pressure of from about 5 to about 30 inches of Hg through the wand to remove internal organs of the lobster; removing the wand to provide a whole lobster having meat which is detached from the shell which meat is not subject to degradation by digestive enzymes.

In a preferred embodiment the invention provides a method described above, further comprising the step of introducing air into the abdomen of the lobster during the application of vacuum pressure.

In another aspect, the invention provides a seafood product comprising a lobster, which lobster has been subjected to the methods herein described.

In yet a further aspect, the invention provides a seafood product comprising an uncooked lobster having an intact shell, wherein the meat of said lobster is detached from the shell and internal organs of the lobster have been removed.

In yet a further aspect, the invention provides the method described herein wherein the wand comprises a first tube and a second tube wherein the first tube comprises a distal end and a proximal end, the proximal end being attachable to a vacuum pump and the distal end comprising a tip adapted for insertion into the lobster and wherein the second tube comprises a distal end and a proximal end, the proximal end being open to enable air to pass into the second tube and the distal end being adapted for insertion into the lobster and wherein the second tube is affixed to the first tube.

### BRIEF DESCRIPTION OF THE DRAWING

Reference will now be made to the drawings, wherein

FIG. 1 is a top view of a lobster, the shaded area illustrating the area where the shell is attached to the meat; and

FIG. 2 shows a side view of a wand adapted for evisceration of a whole lobster.

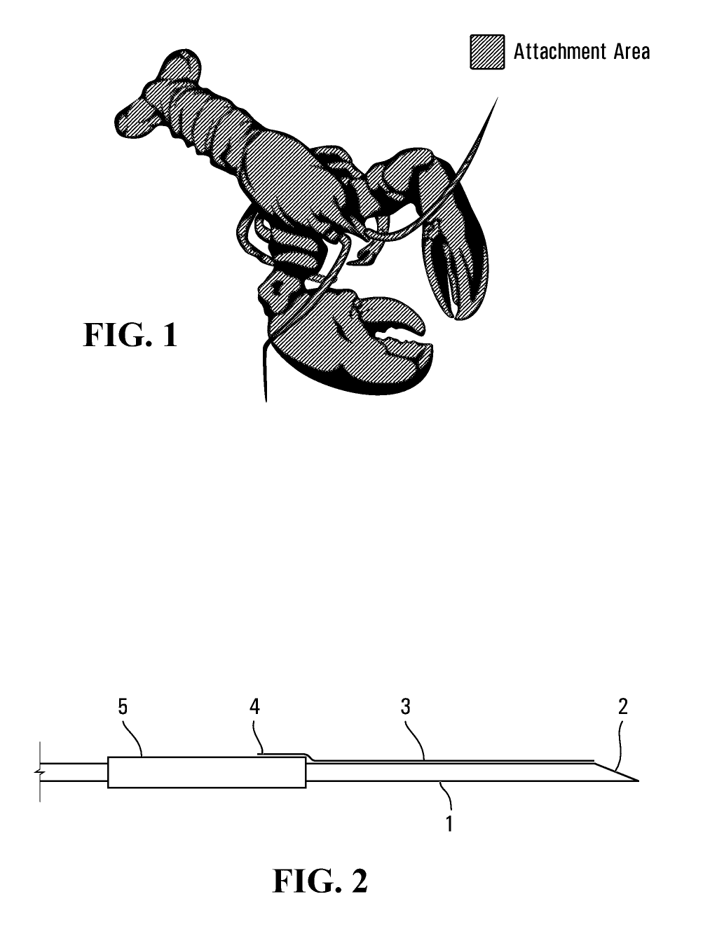

### DETAILED DESCRIPTION OF PREFERRED EMBODIMENTS

The inventors of the present invention were presented with the problem of mushy tail meat in whole lobsters processed using high pressure followed by freezing. Mushy texture in meat products often arises due to insufficiently rapid freezing and thawing cycles. In particular, slow freezing of meat products can result in the development of sharp ice crystals which can pierce cell membranes and produce a mushy texture.

Experiments were conducted by the inventors of the present invention using flash freezing of whole lobsters in liquid nitrogen immediately following high pressure treatment. However, surprisingly, flash freezing did not improve the texture of meat from the tail area of the animal. Similarly, experiments were conducted using gentle thawing of frozen lobster in chilled waterbaths. However, this method also did not succeed in eliminating the occurrence of mushy texture in the tail meat.

In order to evaluate whether digestive enzymes could be responsible for the development of mushy tail meat in lobster, the inventors of the presently claimed invention exposed uncooked lobsters to temperatures of 45 to 50 degrees C. for a period of 45 minutes to one hour. This treatment consistently produced mushy meat in the tail of the lobster in 60% of the animals tested.

Initial attempts were made by the inventors of the presently claimed invention to denature digestive enzymes by immersing lobsters in sodium hypochlorite (common bleach). This process resulted in an unpleasant odour being imparted to the lobster meat and therefore this method was not pursued.

Further investigations were made to develop a method which incorporates the step of removing organs from the lobster which produce digestive enzymes. These methods will now be described in more detail. According to this method, lobster are exposed to pressure for a period of time sufficient to detach the shells so that the meat can be easily extracted. Immediately following high pressure treatment, the lobster is subjected to evisceration to remove internal organs, specifically at least the hepatopancreas and the stomach.

Exposure to high pressure has been previously shown to be useful for removing the shells of lobster while leaving the meat substantially intact. Lobster is exposed to pressure for a period of time sufficient to effect detachment of the body from the shell. The skilled artisan can vary the time and pressure to obtain best results. Generally, detachment can be effected in short periods of time by applying pressure of at least about 25,000 psi. Higher pressures, e.g. about 30,000; 35,000, 40,000; 45,000; 50,000; 55,000; 60,000; 65,000; 70,000; 75,000; 80,000; 85,000; 90,000; 95,000 or 100,000 psi may also be used. Lower pressures, such as about 5,000; 10,000; 15,000; or 20,000 psi may also prove to be sufficient in certain cases. Currently available commercial pressurization equipment is capable of achieving pressures of up to about 100,000 psi, however, pressure greater than this, if achieved, would be effective. Pressure of at least about 25,000 psi is preferred to achieve detachment in a short period of time.

The amount of exposure time required varies with the amount of pressure applied. Specifically, where a higher pressure is used, a shorter exposure time is required. Exposure times of about 15, 30, 45, 60, 75, 90, 105, 120, 135, 150, 165 or 180 seconds are typical, although longer exposure times can be used.

Types of externally applied pressure suitable for use with the subject invention include, without limitation hydrostatic pressure and isostatic pressure. In addition, the subject invention can be used at a wide range of temperatures. Typically, the temperature of the meat of the lobster is between about −2° C. and about 100° C. when pressure is applied. It is therefore possible to carry out the method of the subject invention at ambient temperature (e.g. about 10° C. to about 30° C., typically about 20° C.), or to combine it with cooling or heating of the lobster.

Following pressurization, the shells of lobster are fully detached and can be easily separated from the meat by the consumer. However, for aesthetic reasons, the meat is retained in the shell so that the animal can be provided to the consumer with the appearance of a freshly killed, intact lobster.

The term “about” is used above in connection with the discussion of times, temperatures and pressures, as the skilled person will appreciate that exact times, temperatures and pressures are not essential or critical. The term “about” shall be understood to encompass such variations in time, temperature and pressure as may be appropriate in a particular circumstance to effect detachment of the shell of a lobster from the meat and, in any event, shall be understood to encompass ±5%, 10%, 15%, 20% or 25% of the stated value.

Any apparatus capable of applying pressure of at least about 25,000 psi to the shell of a lobster may be used in the methods of the invention. However, in some applications equipment capable of producing pressure of as little as about 5,000 psi may be useful. Preferred is apparatus that produces hydrostatic pressure. Hydrostatic pressure is pressure which is exerted by a fluid. There is a variety of different commercially available equipment that is suitable for use in the methods of the invention including, for example, the hydrostatic pressure equipment described in U.S. Pat. Nos. 6,537,601 issued Mar. 25, 2003, 6,426,103 issued Jul. 30, 2002, 6,393,977 issued May 28, 2002, and 6,217,435 issued Apr. 17, 2001, all of which are incorporated herein by reference, and which is sold by Avure Technologies Incorporated (Kent, Wash., USA) under the trademark FRESHER UNDER PRESSURE.

The bodies of lobster which have been detached from the shells using the method of the subject invention provide meat which is detached but uncooked. The meat is in a substantially intact form and therefore can be extracted by the consumer without the mincing or flaking. Since the meat is uncooked, it can be cooked immediately before serving, thus providing a fresh taste and avoiding overcooking. The availability of raw, detached, intact lobster offers chefs and consumers the opportunity to prepare and serve a fresh, whole lobster without having to acquire and cook a live animal.

The inventors of the subject application have found that the texture, colour and flavour of the lobster meat can be greatly improved by removal of the lobster's internal organs, specifically at least the hepatopancreas and the stomach, immediately following high pressure treatment and prior to freezing and/or packaging of the whole lobster.

The hepatopancreas is a green coloured organ. It is located in the mid-section of the lobster next to and in contact with the anterior portion of the tail and its presence can result in the tail meat of the lobster becoming tainted with a greenish or blackish colour. Furthermore, the hepatopancreas produces digestive enzymes. The presence of digestive enzymes results in degradation of tissue adjacent to the hepatopancreas with the result that meat in the tail region becomes mushy.

The stomach of the lobster also produces digestive enzymes and therefore its presence can adversely affect the texture of the meat. Furthermore, the presence of the stomach can result in altered flavour and colour of the meat for the additional reason that lobsters frequently consume bait immediately before being trapped and therefore are subject to being cooked with contents still in the stomach.

Evisceration of lobsters is typically performed by vacuum suction through the mouth or through an incision cut into the body of the animal. Aspiration through the mouth results in incomplete evisceration as it fails to remove the anterior lobes of hepatopancreas that extend into the back of the eye regions where the antennal glands are located. Furthermore, aspiration through the oral cavity fails to remove blood from the sinus cavities in the anterior region of the animal. The alternative approach of cutting into the shell of the animal destroys the appearance of the animal as a whole lobster.

The inventors of the subject application have found that suitable vacuum evisceration can be performed using a wand inserted into the abdomen of the lobster which is located in the anterior tail region. This region of the lobster comprises soft tissue which facilitates easy insertion of the vacuum wand and provides direct access to the location of the entire hepatopancreas. A particularly preferred location is the ventral sinus region of the abdomen, which is easily penetrated as it is protected by only a thin membrane rather than the hard shell.

A person of skill in the art can determine a suitable vacuum pressure to use in evisceration. A range of 5 to 30 inches of Hg has been found to be suitable for vacuum evisceration. Excessively high pressure can result in damage to the animal which negatively impacts the appearance of the lobster and the texture of the meat.

The inventors have found that vacuum suction improved when air was introduced into the lobster's body cavity during vacuum evisceration. Air can be introduced through an incision in the animal or through a tube providing a steady stream of air during the evisceration process.

In a preferred embodiment of the invention, both suction and air ventilation are provided using a single wand device having two tubes, one tube providing suction and a second tube providing ventilation.

In a further preferred embodiment of the invention, a transparent section is attached to the evisceration wand to permit the user to visually observe the internal organs being suctioned out of the lobster and visually determine when evisceration is complete.

In a still further preferred embodiment, the progress of evisceration can be monitored visually by manual lifting of the hard shell covering the lobster's head and thorax (the “carapace”) during evisceration. By lifting the carapace, it is possible to see inside the body cavity of the lobster and observe when removal of the internal organs is complete. After evisceration is complete, the carapace is returned to its former position to return the lobster to its natural appearance.

Vacuum evisceration results in removal of internal organs of the lobster. In order to ensure that digestive enzymes are removed, evisceration should result in removal of the hepatopancreas and the stomach. However, other organs can also be removed during evisceration including the antennal glands, the gonads and, sometimes, all or part of the heart of the lobster.

In a further embodiment of the present invention, there is provided a wand for use in eviscerating lobsters. Referring to FIG. 2, the wand comprises two tubes, a first tube (1) being a hollow tube for use in providing suction. The proximal end of the suction tube can be attached via a hose to a vacuum pump. The distal end of the suction tube comprises a tip (2), which tip may be blunt or pointed in a needle-type shape. The tip may comprise a single opening or multiple openings in the form of holes or slots. The suction tube may be made of any rigid material including e.g. stainless steel.

The second tube is a ventilation tube (3) which is affixed to the suction tube. The proximal end (4) of the ventilation tube is open such that air can pass into the ventilation tube. The distal end of the ventilation tube is inserted into the lobster alongside the suction tube. The ventilation tube can be made of any rigid material including e.g. stainless steel.

In a preferred embodiment, the apparatus comprising the wand and the hose include a transparent portion (5), such as a transparent handle or a portion of transparent tubing so as to enable the user to visually monitor the removal of internal organs from the lobster.

As will be appreciated by one of skill in the art, any type of vacuum pump can be used in the methods of the subject invention. For example, a rotary vane pump can be used with vacuum chambers adapted to collect the viscera of the animal as it is evacuated from the animal.

Alternatively, an air-actuated diaphragm pump can be used which allows for evacuated materials to be passed directly through the pump.

Following vacuum evisceration as herein described, the animal can be packaged for transport and, optionally, frozen.

The invention will now be further illustrated by the following non-limiting examples.

### Example 1

### Impact of Freezing Method

Lobsters were processed using high pressure treatment at 29,000 psi for 45 seconds. Following pressurization, the lobsters were frozen by passage through a nitrogen tunnel for 15 minutes at −145 degrees C. Frozen lobsters were thawed by water immersion over a three hour period.

Thawed lobsters were cooked using exposure to steam for 18 minutes.

The appearance of the nitrogen frozen meat was inferior to the appearance of meat frozen using regular methods. No significant improvement in the flavour or texture of meat was observed using nitrogen freezing.

### Example 2

### Impact of Evisceration and Flushing

Lobsters were processed using high pressure treatment at 29,000 psi for 45 seconds. Following pressure treatment, the lobsters were eviscerated using vacuum aspiration through the oral cavity using a rotary vane vacuum pump with collecting chambers at a working vacuum pressure that varied between 5 and 30 inches of Hg. Evisceration resulted in removal of all of the hepatopancreas in 75% of the animals and minor traces of the hepatopancreas in the remaining 25% of the animals. A subset of the eviscerated lobsters were flushed with water following evisceration and water was extracted with a suction device.

Following evisceration, the lobsters were cooked by exposure to steam for 18 minutes. The results indicated that eviscerated lobsters were superior to uneviscerated lobsters in the whiteness of the meat, the texture and the flavour. Those lobsters which were flushed following evisceration showed a very slightly inferior appearance and a very slightly superior flavour and texture over the eviscerated lobster, although these differences were not significant.

### Example 3

### Impact of Evisceration Using an Anterior Wand

Live lobsters were processed using high pressure treatment at 29,000 psi for 45 seconds. Following pressure treatment, the lobsters were eviscerated vacuum aspiration using an air-actuated diaphragm pump at a working vacuum pressure that varied between 5 and 30 inches of Hg. One subset of these lobsters was eviscerated by inserting the vacuum wand through the oral cavity of the lobster. The other subset of lobsters was eviscerated by inserting the vacuum wand through the sinus region of the ventral abdomen.

Each of the two subsets were split open to determine the effectiveness of the evisceration process by observing the completeness of the viscera removal. In all cases of wand insertion through the oral cavity, a fraction of the hepatopancreas remained in the anterior region of the lobster body behind the eyes where the antennal glands are located. In all cases of the wand insertion through the abdomen, no traces of hepatopancreas were left behind following the evisceration process.

The results indicate that superior removal of the hepatopancreatic tissue is achieved by insertion of the vacuum wand through the ventral sinus region of the abdomen.

### Example 4

### Impact of Air Ventilation

50 live lobsters of equal weight were processed using high pressure treatment at 29,000 psi for 45 seconds. Following pressure treatment, the lobsters were put into two groups. Group 1 consisted of 25 lobsters that were eviscerated by vacuum aspiration using a hollow tube vacuum wand attached to an air-actuated diaphragm pump at a working vacuum pressure that varied between 5 and 30 inches of Hg. Group 2 consisted of 25 of the lobsters that were eviscerated by vacuum aspiration using a hollow tube vacuum wand attached to an air-actuated diaphragm pump at a working vacuum pressure that varied between 5 and 30 inches of Hg. Attached to this vacuum wand was an inline ventilation tube with one end that was inserted into the lobster body along with the vacuum wand and the other end remaining outside of the lobster body to allow air to enter the body during the evisceration process. In each case with both groups, the lobsters were eviscerated by inserting the vacuum wand through the ventral sinus region of the lobster's abdomen. The evisceration of each group of lobsters was timed from start to finish.

The results indicate that evisceration using a vacuum wand with attached ventilating tube required 20% less time to completely evacuate the hepatopancreas and the stomach from the complete set of lobsters in Group 2.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

As used in this specification and the appended claims, the singular forms “a,” “an,” and “the” include plural reference unless the context clearly dictates otherwise. Unless defined otherwise all technical and scientific terms used herein have the same meaning as commonly understood to one of ordinary skill in the art to which this invention belongs.

1. A method of processing a whole lobster comprising:
exposing the whole lobster to external pressure of at least 25,000 psi for a period of time sufficient to effect detachment of the meat from the shell;
removing the internal organs of the lobster through an aperture in the abdomen of the lobster.

2. A method of processing a whole lobster comprising:
inserting a wand comprising a hollow tube into the abdomen of the lobster;
applying vacuum pressure of from about 5 to about 25 inches of Hg through the wand to remove internal organs of the lobster;
removing the wand to provide a whole lobster having meat which is detached from the shell which meat is not subject to degradation by digestive enzymes.

3. The method of claim 2, further comprising the step of introducing air into the abdomen of the lobster during the application of vacuum pressure.

4. The method of claim 3 wherein the air is introduced using a second tube affixed to the wand.

5. The method of claim 1 further comprising determining the extent of evisceration by lifting the carapace of the lobster to reveal the body cavity and thereafter returning the carapace to its original position.

6. The method of claim 1 wherein the internal organs comprise the hepatopancreas and the stomach.

7. The method of claim 1 wherein the external pressure is maintained for a period of at least about 15 seconds.

8. The method of claim 1 wherein said external pressure is hydrostatic pressure.

9. The method of claim 2 wherein the wand comprises a transparent tube.

10. The method of claim 1 wherein the abdomen of the lobster comprises a ventral sinus region of the abdomen of the lobster.

11. The method of claim 1 which further comprises the step of freezing the lobster following removal of the internal organs.

12. A seafood product comprising a lobster, which lobster has been subjected to the method of claim 1.

13. A seafood product comprising a lobster, which lobster has been subjected to the method of claim 2.

14. A seafood product comprising a lobster, which lobster has been subjected to the method of claim 3.

15. A seafood product comprising a lobster, which lobster has been subjected to the method of claim 4.

16. A seafood product comprising a lobster, which lobster has been subjected to the method of claim 5.

17. A seafood product comprising an uncooked lobster having an intact shell, wherein the meat of said lobster is detached from the shell and internal organs of the lobster have been removed.

18. The method of claim 2 wherein the wand comprises a first tube and a second tube wherein the first tube comprises a distal end and a proximal end, the proximal end being attached to a vacuum pump and the distal end comprising a tip adapted for insertion into the lobster and wherein the second tube comprises a distal end and a proximal end, the proximal end being open to enable air to pass into the second tube and the distal end being adapted for insertion into the lobster and wherein the second tube is affixed to the first tube.
